(19) United States
(12) Patent Application Publication
(10) Pub. No.: US 2018/0329257 A1
(43) Pub. Date: Nov. 15, 2018

(54) DISPLAY SUBSTRATE, DISPLAY APPARATUS, AND FABRICATING METHOD THEREOF

(71) Applicants: BOE TECHNOLOGY GROUP CO., LTD., Beijing (CN); Beijing BOE Multimedia Technology Co., Ltd., Beijing (CN)

(72) Inventor: Xiangchun Xiao, Beijing (CN)

(73) Assignees: BOE TECHNOLOGY GROUP CO., LTD., Beijing (CN); Beijing BOE Multimedia Technology Co., Ltd., Beijing (CN)

(21) Appl. No.: 15/578,551

(22) PCT Filed: Jul. 4, 2017
(86) PCT No.: PCT/CN2017/091655

§ 371 Date: Nov. 30, 2017

(30) Foreign Application Priority Data
Oct. 19, 2016 (CN) 201610911975.9

(51) Int. Cl. G02F 1/1335; G02F 1/1333; G02F 1/1368; G02F 1/1362; G02F 1/1343; G06F 3/041

(52) U.S. Cl. CPC G02F 1/133553; G02F 1/13338; G02F 1/1368; G02F 1/136286; G06F 3/044; G02F 1/134309; G02F 1/133528; G06F 3/0412; G02F 2001/134345; G02F 1/13439

(57) ABSTRACT

The present application discloses a display substrate having a subpixel region and an inter-subpixel region. The display substrate includes a base substrate, and a reflective structure in the inter-sub pixel region configured to reflect light emitted from a back light toward the inter-subpixel region of the display substrate back to the back light while allowing light transmit through the subpixel region.

### CROSS-REFERENCE TO RELATED APPLICATION

This application claims priority to Chinese Patent Application No. 201610911975.9, filed Oct. 19, 2016, the contents of which are incorporated by reference in the entirety.

### TECHNICAL HELD

The present invention relates to display technology, more particularly, to a display substrate, a display apparatus having the same, and a fabricating method thereof.

### BACKGROUND

Liquid crystal display panels have found a wide variety of applications. Typically, a liquid crystal display panel includes a color filter substrate and an array substrate facing each other. Thin film transistors, gate lines, data lines, pixel electrodes, common electrodes, and common electrode lines are disposed on the array substrate or the color filter substrate. Between the array substrate and the color filter substrate, a liquid crystal material is injected to form a liquid crystal layer. A passivation layer is deposited on the thin film transistor. A pixel electrode layer is disposed on the passivation layer.

### SUMMARY

In one aspect, the present invention provides a display substrate having a subpixel region and an inter-subpixel region, comprising a base substrate, and a reflective structure in the inter-subpixel region configured to reflect light emitted from a back light toward the inter-subpixel region of the display substrate back to the back light while allowing light transmit through the subpixel region.

Optionally, the display substrate further comprises a plurality of thin film transistors and a plurality of signal lines for driving light emission of the display substrate; wherein the reflective structure is on a side of the plurality of thin film transistors and the plurality of signal lines proximal to the back light.

Optionally, a projection of the reflective structure on the base substrate substantially covers projections of a plurality of gate lines and a plurality of data lines on the base substrate.

Optionally, the reflective structure comprises a plurality of touch electrodes configured to detect a touch; each of the plurality of touch electrodes is light reflective and configured to reflect light emitted from the back light toward the inter-subpixel region of the display substrate back to the back light.

Optionally, the reflective structure comprises a plurality of first reflective strips arranged along a first direction, each of the plurality of first reflective strips extending substantially along a second direction; and a plurality of second reflective strips arranged along the second direction, each of the plurality of second reflective strips extending substantially along the first direction.

Optionally, the reflective structure comprises a first reflective layer comprising a plurality of first reflective strips arranged along a first direction, each of the plurality of first reflective strips extending substantially along a second direction; a second reflective layer comprising a plurality of second reflective strips arranged along the second direction, each of the plurality of second reflective strips extending substantially along the first direction; and an insulating layer between the first reflective layer and the second reflective layer.

Optionally, the plurality of first reflective strips constitute a plurality of first touch electrodes; and the plurality of second reflective strips constitute a plurality of second touch electrodes.

Optionally, m numbers of adjacent reflective strips of the plurality of first reflective strips are connected in parallel to form one of the plurality of first touch electrodes; n numbers of adjacent reflective strips of the plurality of second reflective strips are connected in parallel to form one of the plurality of second touch electrodes; and m=3n.

Optionally, the display substrate further comprises a plurality of first transparent conductive blocks, each of which electrically connected to one of the plurality of first reflective strips; wherein a projection of each of the plurality of first transparent conductive blocks on the base substrate is between projections of two adjacent second reflective strips of the plurality of second reflective strips on the base substrate.

Optionally, the plurality of first transparent conductive blocks comprise a plurality of rows of first transparent conductive blocks; and any two adjacent first transparent conductive blocks in each row of the plurality of rows of first transparent conductive blocks are electrically connected to two adjacent first reflective strips of the plurality of first reflective strips.

Optionally, each of the plurality of first transparent conductive blocks has a rectangular shape,

Optionally, the display substrate further comprises a plurality of second transparent conductive blocks, each of which electrically connected to one of the plurality of second reflective strips; wherein a projection of each of the plurality of second transparent conductive blocks on the base substrate is between projections of two adjacent first reflective strips of the plurality of first reflective strips on the base substrate.

Optionally, the plurality of first transparent conductive blocks comprise a plurality of rows of first transparent conductive blocks; the plurality of second transparent conductive blocks comprise a plurality of rows of second transparent conductive blocks; each of the plurality of rows of first transparent conductive blocks and each of the plurality of rows of second transparent conductive blocks are alternating with each other; any two adjacent first transparent conductive blocks in each row of the plurality of rows of first transparent conductive blocks are electrically connected to two adjacent first reflective strips of the plurality of first reflective strips; and each second transparent conductive block in a same row of the plurality of rows of second transparent conductive blocks is electrically connected to a same second reflective strip of the plurality of second reflective strips.

Optionally, the plurality of first transparent conductive blocks and the plurality of second transparent conductive blocks are in a same layer.

Optionally, each of the plurality of first transparent conductive blocks has a rhomboid shape; and each of the plurality of second transparent conductive blocks has a rhomboid shape.

Optionally, the display substrate further comprises a polarizer on the base substrate; wherein the polarizer is on a side of the plurality of thin film transistors and the plurality of signal lines distal to the base substrate.

Optionally, the reflective structure is on a side of the base substrate proximal to the polarizer.

Optionally, the reflective structure is on a side of the polarizer proximal to light incident side of the display substrate.

In another aspect, the present invention provides a display apparatus comprising the display substrate described herein.

In another aspect, the present invention provides a method of fabricating a display substrate having a subpixel region and an inter-subpixel region, comprising forming a reflective structure in the inter-subpixel region configured to reflect light emitted from a back light toward the inter-subpixel region of the display substrate back to the back light while allowing light transmit through the subpixel region.

### BRIEF DESCRIPTION OF THE FIGURES

The following drawings are merely examples for illustrative purposes according to various disclosed embodiments and are not intended to limit the scope of the present invention.

FIG. 1 is a diagram illustrating a subpixel region and an inter-subpixel region of a display substrate in some embodiments according to the present disclosure.

FIG. 2 is a diagram illustrating the structure of a reflective structure in the inter-subpixel region of a display substrate in some embodiments according to the present disclosure.

FIG. 3 is a cross-sectional view along the A-A′ line of the display substrate in FIG. 2 in some embodiments according to the present disclosure.

FIG. 4 is a cross-sectional view along the A-A′ line of the display substrate in FIG. 2 in some embodiments according to the present disclosure.

FIG. 5 is a cross-sectional view along the A-A′ line of the display substrate in FIG. 2 in some embodiments according to the present disclosure.

FIGS. 6A to 6F are cross-sectional views along the A-A′ line of e display substrate in FIG. 2 in some embodiments according to the present disclosure.

FIG. 7 is a schematic diagram illustrating the structure of a reflective structure in some embodiments according to the present disclosure.

FIG. 8 is a cross-sectional view of a reflective structure in some embodiments according to the present disclosure.

FIG. 9 is a schematic diagram illustrating the structure of a reflective structure in some embodiments according to the present disclosure.

FIG. 10 is a cross-sectional view of a reflective structure in some embodiments according to the present disclosure.

FIG. 11 is a schematic diagram illustrating the structure of a reflective structure in some embodiments according to the present disclosure.

FIG. 12 is a cross-sectional view of a reflective structure in some embodiments according to the present disclosure.

FIG. 13 is a schematic diagram illustrating the structure of a reflective structure in some embodiments according to the present disclosure.

FIG. 14 is a cross-sectional view of a reflective structure in some embodiments according to the present disclosure.

FIG. 15 is a schematic diagram illustrating the structure of a polarizer in some embodiments according to the present disclosure.

FIG. 16 is a schematic diagram illustrating the structure of a display panel in some embodiments according to the present disclosure.

FIG. 17 is a schematic diagram illustrating the structure of a display apparatus in some embodiments according to the present disclosure.

FIG. 18 is a schematic diagram illustrating the structure of a display apparatus in some embodiments according to the present disclosure.

### DETAILED DESCRIPTION

The disclosure will now be described more specifically with reference to the following embodiments. It is to he noted that the following descriptions of some embodiments are presented herein for purpose of illustration and description only. It is not intended to be exhaustive or to be limited to the precise form disclosed.

Conventional display panels includes a plurality of subpixels. The display panels have a subpixel region and an inter-subpixel region. Signal lines such as gate lines and data lines are typically disposed in the inter-subpixel region, which is not light transmissive. When light emitted from a back light into the inter-subpixel region is absorbed, reducing light utilization rate of the display panel. To increase the light utilization rate in the conventional display panels, the inter-subpixel region is made as small as possible. For example, the signal lines and the black matrix in the conventional display panels are made to have a small width. However, the effectiveness of these methods is very limited.

Accordingly, the present disclosure provides, inter alia, a display substrate, a display apparatus having the same, and a fabricating method thereof that substantially obviate one or more of the problems due to limitations and disadvantages of the related art. In one aspect, the present disclosure provides a display substrate having a subpixel region and an inter-subpixel region. In some embodiments, the display substrate includes a base substrate, and a reflective structure in the inter-subpixel region configured to reflect light emitted from a back light toward the inter-subpixel region of the display substrate back to the back light while allowing light transmit through the subpixel region.

As used herein, a subpixel region refers to a light emission region of a subpixel, such as a region corresponding to a pixel electrode in a liquid crystal display, or a region corresponding to a light emissive layer in an organic light emitting diode display panel. Optionally, a pixel may include a number of separate light emission regions corresponding to a number of subpixels in the pixel. Optionally, the subpixel region is a light emission region of a red color subpixel. Optionally, the subpixel region is a light emission region of a green color subpixel. Optionally, the subpixel region is a light emission region of a blue color subpixel. Optionally, the subpixel region is a light emission region of a white color subpixel.

As used herein, an inter-subpixel region refers to a region between adjacent subpixel regions, such as a region corresponding to a black matrix in a liquid crystal display, or a region corresponding a pixel definition layer in an organic light emitting diode display panel. Optionally, the inter-subpixel region is a region between adjacent subpixel regions in a same pixel. Optionally, the inter-subpixel region is a region between two adjacent subpixel regions from two adjacent pixels. Optionally, the inter-subpixel region is a region between a subpixel region of a red color subpixel and a subpixel region of an adjacent green color subpixel. Optionally, the inter-subpixel region is a region between a subpixel region of a red color subpixel and a subpixel region of an adjacent blue color subpixel. Optionally, the inter-subpixel region is a region between a subpixel region of a green color subpixel and a subpixel region of an adjacent blue color subpixel.

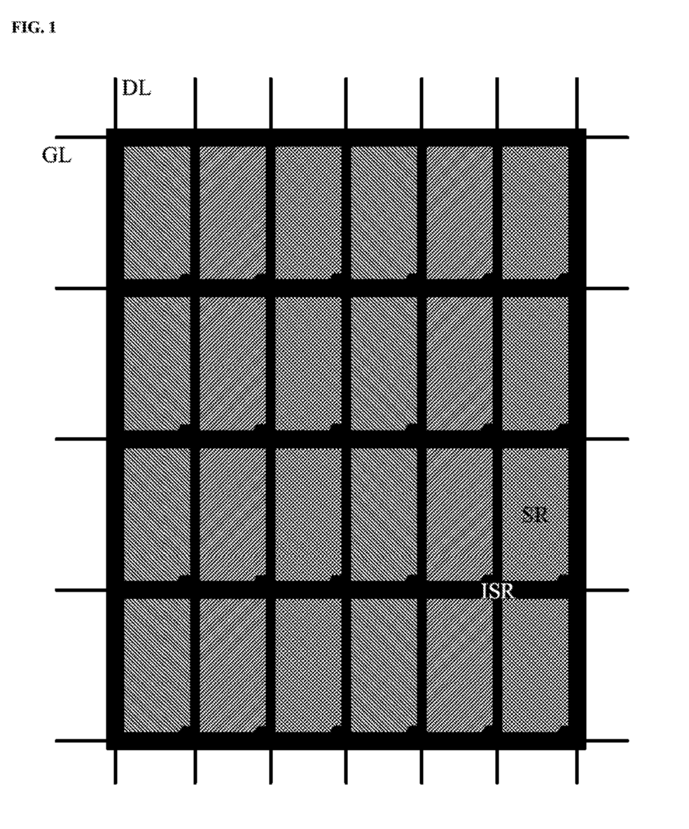

FIG. 1 is a diagram illustrating a subpixel region and an inter-subpixel region of a display substrate in some embodiments according to the present disclosure. Referring to FIG. 1, the display substrate in some embodiments further includes a plurality of signal lines, such as a plurality of gate lines GL and a plurality of data lines DL. The plurality of signal lines are typically disposed in the inter-subpixel region ISR and outside the subpixel region SR.

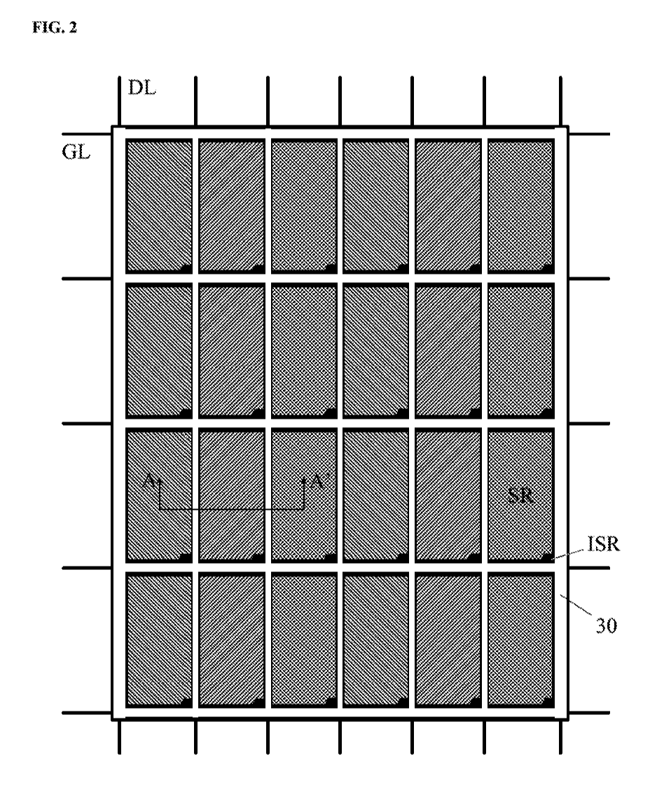

FIG. 2 is a diagram illustrating the structure of a reflective structure in the inter-subpixel region of a display substrate in some embodiments according to the present disclosure. Referring to FIG. 2, the display substrate in some embodiments further includes a reflective structure 30. The reflective structure 30 is disposed in the inter-subpixel region ISR. Optionally, the display substrate is an array substrate, which further includes a plurality of thin film transistors and a plurality of signal lines for driving light emission of the display substrate. The plurality of signal lines correspond to the inter-subpixel region ISR. Optionally, the display substrate is a color filter substrate, which further includes a plurality of color filters and a black matrix. The black matrix in the color filter substrate corresponds to the inter-subpixel region ISR, and the plurality of color filters correspond to the subpixel region SR.

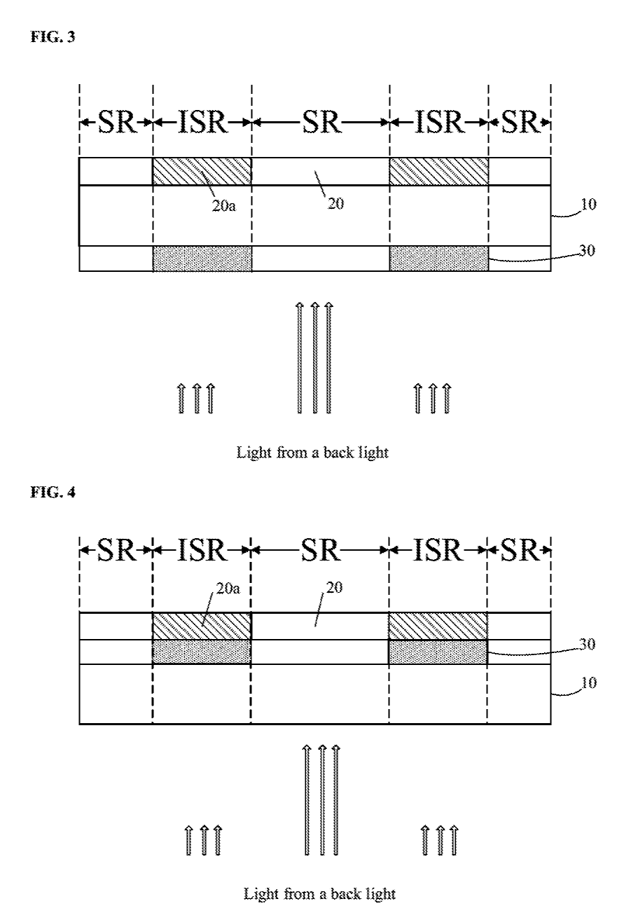

FIG. 3 is a cross-sectional view along the A-A′ line of the display substrate in FIG. 2 in some embodiments according to the present disclosure. Referring to FIG. 3, the display substrate in some embodiments includes a first base substrate 10, and a reflective structure 30 on the first base substrate 10. The reflective structure 30 is in the inter-subpixel region ISR and is configured to reflect light emitted from a back light toward the inter-subpixel region ISR of the display substrate back to the back light. The light emitting toward the subpixel region SR is not affected by the reflective structure 30, and transmits through the subpixel region SR for image display. By having the reflective structure 30 in the inter-subpixel region ISR, absorption of light transmitted from the back light by a plurality of signal lines (e.g., a plurality of gate lines and a plurality of data lines) in the inter-subpixel region ISR can be avoided. The reflective structure 30 reflects this portion of light back to the back light, so that this portion of light can be re-utilized for image display. Light utilization rate in a display apparatus having the present display substrate can be significantly enhanced.

The display substrate further includes various pixel components on the first base substrate 10. Optionally, the display substrate is an array substrate, and includes a plurality of pixel electrodes and a plurality of common electrodes in the subpixel region SR, e.g., in the area 20 denoted in FIG. 3. Optionally, the display substrate is an array substrate, and includes a plurality of thin film transistors and a plurality of signal lines (e.g., a plurality of gate lines and a plurality of data lines) in the inter-subpixel region ISR, e.g., in the area 20a denoted in FIG. 3. Optionally, the display substrate is a color filter substrate, and includes a plurality of color filter in the subpixel region SR, e.g., in the area 20 denoted in FIG. 3. Optionally, the display substrate is a color filter substrate, and includes a black matrix layer in the inter-subpixel region ISR, e.g., in the area 20a denoted in FIG. 3. As shown in FIG. 3, the reflective structure 30 is on a side of the pixel components (e.g., the plurality of thin film transistors and the plurality of signal lines) proximal to the back light. Optionally, the reflective structure 30 is on a side of the pixel components (e.g., the plurality of thin film transistors and the plurality of signal lines) proximal to a light incident side of the display substrate.

Optionally, the first base substrate 10 is between the reflective structure 30 and various pixel components of the display substrate (e.g., the plurality of thin film transistors and the plurality of signal lines), as depicted in FIG. 3. The reflective structure 30 is on a side of the first base substrate 10 proximal to the light incident side of the display substrate, e.g., proximal to the back light.

FIG. 4 is a cross-sectional view along the A-A′ line of the display substrate in FIG. 2 in some embodiments according to the present disclosure. Referring to FIG. 4, the reflective structure 30 is between the first base substrate 10 and various pixel components of the display substrate (e.g., the plurality of thin film transistors and the plurality of signal lines). The reflective structure 30 is on a side of the first base substrate 10 distal to the light incident side of the display substrate, e.g., distal to the back light

In some embodiments, the reflective structure 30 is formed on the first base substrate 10 directly by a patterning process, as shown in FIG. 3 and FIG. 4. By having the reflective structure 30 formed directly on the first base substrate 10, the reflective structure 30 expands when heated and contracts when cooled together with the first base substrate 10 to substantially the same degree. Accordingly, the positions of the reflective structure 30 relative to the pixel components remain substantially unchanged when ambient temperature undergoes variations. By having this design, misalignment between the reflective structure 30 and the pixel components of the display substrate can be avoided, enhancing the display quality of image display in a display panel having the display substrate.

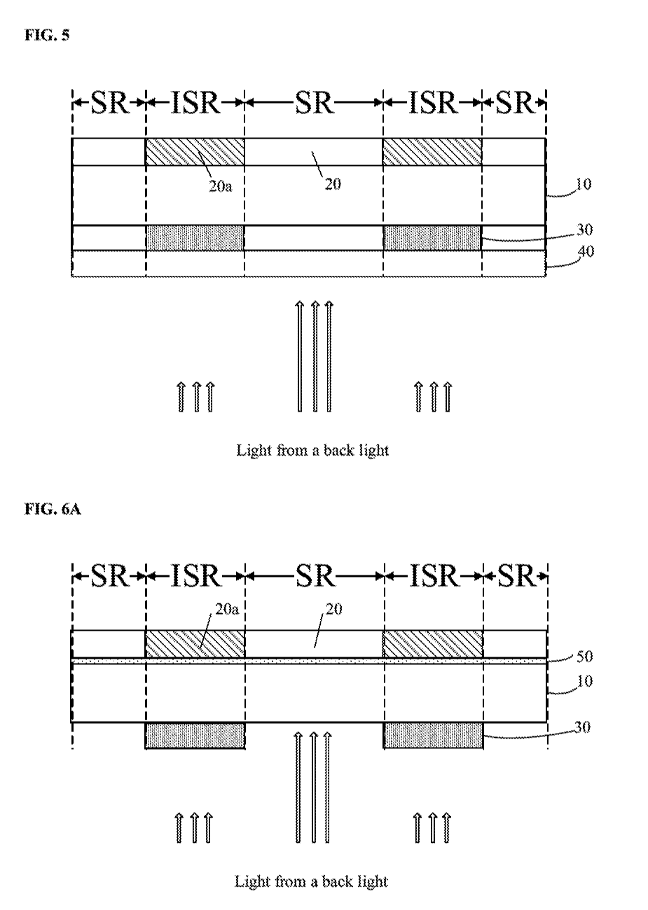

In some embodiments, the reflective structure 30 is adhered onto the first base substrate 10. FIG. 5 is a cross-sectional view along the A-A′ line of the display substrate in FIG. 2 in some embodiments according to the present disclosure. Referring to FIG. 5, the display substrate further includes a second base substrate 40. The reflective structure 30 is between the first base substrate 10 and the second base substrate 40. The display substrate in FIG. 5 differs from those in FIG. 3 and FIG. 4 in that the reflective structure 30 in FIG. 5 is formed on the second base substrate 40 and then adhered onto the first base substrate 10, e.g., using an adhesive layer whereas the reflective structure 30 in FIG. 3 and FIG. 4 is formed directly on the first base substrate 10, e.g., by patterning.

In some embodiments, the display substrate further includes a polarizer. Optionally, the polarizer is between the reflective structure 30 and the pixel components of the display substrate. Optionally, the reflective structure 30 is between the polarizer and the pixel components of the display substrate. Optionally, the polarizer and the reflective structure 30 are on a same side of the first base substrate 10. Optionally, the polarizer and the reflective structure 30 are on different sides of the first base substrate 10, e.g., the polarizer is on a side of the first base substrate 10 distal to the reflective structure 30.

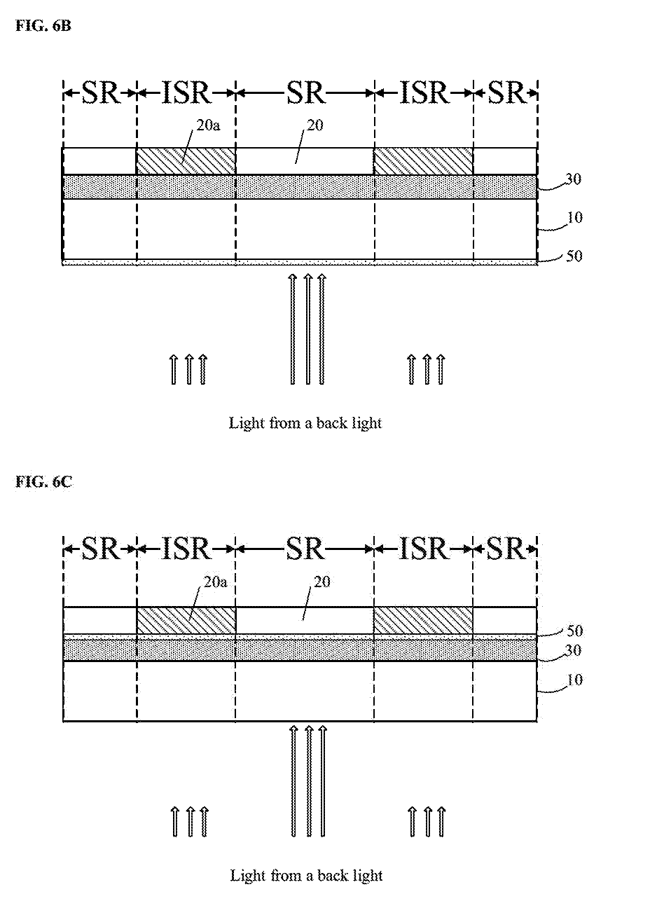

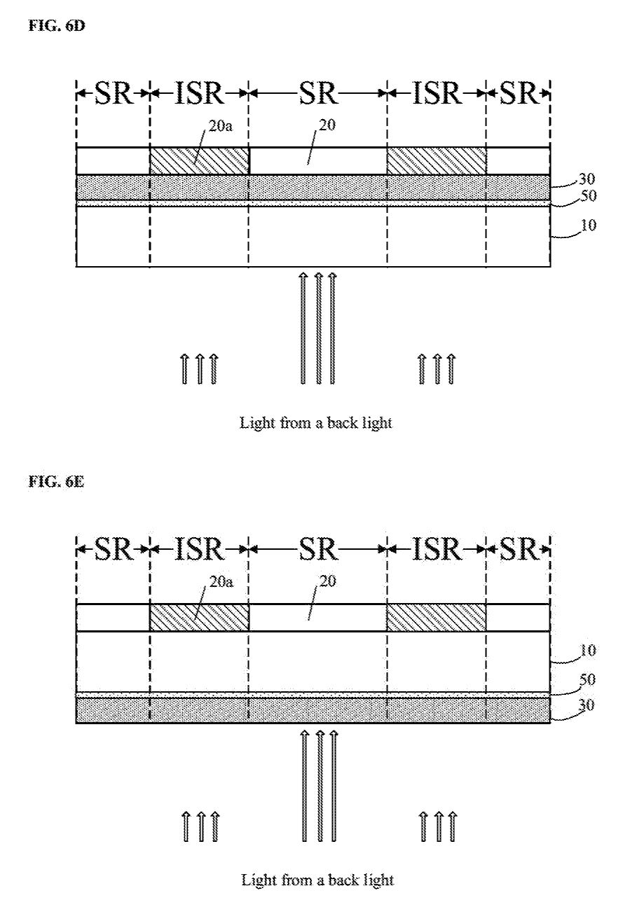

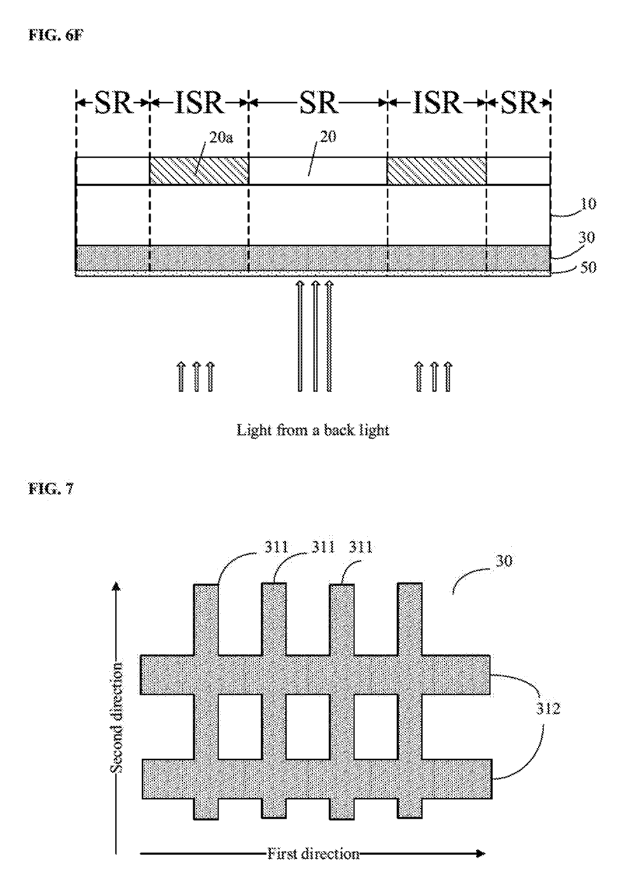

FIGS. 6A to 6F are cross-sectional views along the A-A′ line of the display substrate in FIG. 2 in some embodiments according to the present disclosure. The display substrates in FIGS. 6A to 6F include a polarizer 50. Referring to FIG. 6A and FIG. 6B, the polarizer 50 is on a side of the first base substrate 10 distal to the reflective structure 30, e.g., the polarizer 50 and the reflective structure 30 are on two opposite sides of the first base substrate 10. In FIG. 6A, the display substrate includes a reflective structure 30, a first base substrate 10 on the reflective structure 30, a polarizer 50 on a side of the first base substrate 10 distal to the reflective structure 30, and various pixel components (e.g., a plurality of thin film transistors and a plurality of signal lines) on a side of the polarizer 50 distal to the first base substrate 10. In FIG. 6B, the display substrate includes a polarizer 50, a first base substrate 10 on the polarizer 50, a reflective structure 30 on a side of the first base substrate 10 distal to the polarizer 50, and various pixel components (e.g., a plurality of thin film transistors and a plurality of signal lines) on a side of the reflective structure 30 distal to the first base substrate 10.

Referring to FIG. 6C and FIG. 6D, the polarizer 50 and the reflective structure 30 are on a same side of the first base substrate 10. Moreover, in FIG. 6C and FIG. 6D, the polarizer 50, the reflective structure 30, and pixel components of the display substrate (e.g., a plurality of thin film transistors and a plurality of signal lines) are on a same side of the first base substrate 10. In FIG. 6C, the display substrate includes a first base substrate 10, a reflective structure 30 on the first base substrate 10, a polarizer 50 on a side of the reflective structure 30 distal to the first base substrate 10, and various pixel components (e.g., a plurality of thin film transistors and a plurality of signal lines) on a side of the polarizer 50 distal to the reflective structure 30. In FIG. 6D, the display substrate includes a first base substrate 10, a polarizer 50 on the first base substrate 10, a reflective structure 30 on a side of polarizer 50 distal to the first base substrate 10, and various pixel components (e.g., a plurality of thin film transistors and a plurality of signal lines) on a side of the reflective structure 30 distal to the polarizer 50.

Referring to FIG. 6E and FIG. 6F, the polarizer 50 and the reflective structure 30 are on a same side of the first base substrate 10. Moreover, the polarizer 50 and the reflective structure 30 are on a side of the first base substrate 10 distal to various pixel components (e.g., a plurality of thin film transistors and a plurality of signal lines) of the display substrate. In FIG. 6E, the display substrate includes a reflective structure 30, a polarizer 50 on the reflective structure 30, a first base substrate 10 on a side of the polarizer 50 distal to the reflective structure 30, and various pixel components (e.g., a plurality of thin film transistors and a plurality of signal lines) on a side of the first base substrate 10 distal to the polarizer 50. In FIG. 6F, the display substrate includes a polarizer 50, a reflective structure 30 on the polarizer 50, a first base substrate 10 on a side of the reflective structure 30 distal to the polarizer 50, and various pixel components (e.g., a plurality of thin film transistors and a plurality of signal lines) on a side of the first base substrate 10 distal to the reflective structure 30.

Referring to FIGS. 6A, 6C, and 6E, the reflective structure 30 in some embodiments is on a side of the polarizer 50 proximal to the back light, e.g., proximal to the light incident side of the display substrate. By having the reflective structure 30 on a side of the polarizer 50 proximal to the back light, the light from the back light toward the inter-subpixel region of the display substrate is reflected back to the back light before it is absorbed by the polarizer 50, further enhancing light utilization rate of the display substrate.

FIG. 7 is a schematic diagram illustrating the structure of a reflective structure in some embodiments according to the present disclosure. FIG. 8 is a cross-sectional view of a reflective structure in some embodiments according to the present disclosure. Referring to FIG. 7, the reflective structure 30 in some embodiments includes a plurality of first reflective strips 311 arranged along a first direction, each of the plurality of first reflective strips 311 extending substantially along a second direction; and a plurality of second reflective strips 312 arranged along the second direction, each of the plurality of second reflective strips 312 extending substantially along the first direction. In some embodiments, a projection of the reflective structure 30 on the base substrate substantially covers projections of the plurality of signal lines on the base substrate. As shown in FIG. 7 and FIG. 8, the plurality of first reflective strips 311 and the plurality of second reflective strips 312 in some embodiments are in a same layer. As used herein, the term “same layer” refers to the relationship between the layers simultaneously formed in the same step. In one example, the plurality of first reflective strips 311 and the plurality of second reflective strips 312 are in a same layer when they are formed as a result of one or more steps of a same patterning process performed in a same layer of material. In another example, the plurality of first reflective strips 311 and the plurality of second reflective strips 312 can be formed in a same layer by simultaneously performing the step of forming the plurality of first reflective strips 311 and the step of forming and the plurality of second reflective strips 312. The term “same layer” does not always mean that the thickness of the layer or the height of the layer in a cross-sectional view is the same.

Optionally, the display substrate includes a plurality of data lines arranged substantially along the first direction, each of the plurality of data lines extending substantially along the second direction; and a plurality of gate lines arranged substantially along the second direction, each of the plurality of gate lines extending substantially along the first direction. Optionally, projections of the plurality of first reflective strips 311 on the base substrate substantially covers projections of the plurality of data lines on the base substrate; and projections of the plurality of second reflective strips 312 on the base substrate substantially covers projections of the plurality of gate lines on the base substrate.

Optionally, the display substrate includes a plurality of gate lines arranged substantially along the first direction, each of the plurality of gate lines extending substantially along the second direction; and a plurality of data lines arranged substantially along the second direction, each of the plurality of data lines extending substantially along the first direction. Optionally, projections of the plurality of first reflective strips 311 on the base substrate substantially covers projections of the plurality of gate lines on the base substrate; and projections of the plurality of second reflective strips 312 on the base substrate substantially covers projections of the plurality of data lines on the base substrate.

In some embodiments, the display substrate is a color filter substrate having a plurality of color filters and a black matrix. Optionally, the projection of the reflective structure 30 on the base substrate substantially overlaps with that of the black matrix layer. Optionally, the projection of the black matrix layer on the base substrate substantially covers that of the reflective structure 30.

Various appropriate reflective materials may be used for making the plurality of first reflective strips 311 and the plurality of second reflective strips 312. In some embodiments, the plurality of first reflective strips 311 and the plurality of second reflective strips 312 are made of a metal material.

Referring to FIG. 8, the reflective structure 30 in some embodiments further includes a transparent protective layer 313 on the first reflective strips 311 and the plurality of second reflective strips 312 to protect the first reflective strips 311 and the plurality of second reflective strips 312. Examples of appropriate protective materials include, but are not limited to, resin, silicon dioxide, silicon nitride, polyethylene terephthalate, and so on.

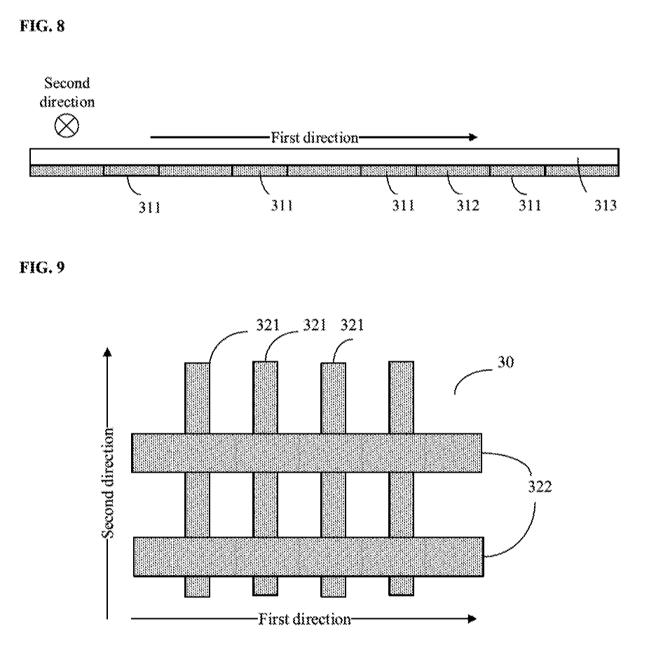

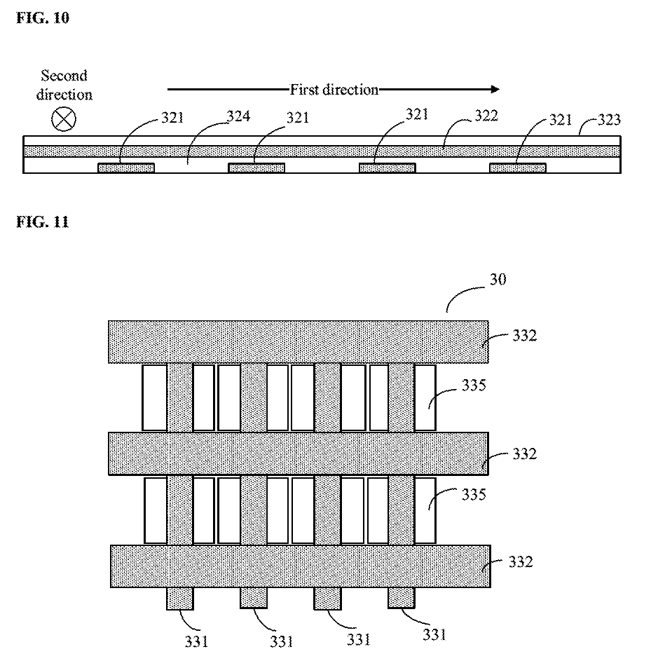

FIG. 9 is a schematic diagram illustrating the structure of a reflective structure in some embodiments according to the present disclosure. FIG. 10 is a cross-sectional view of a reflective structure in some embodiments according, to the present disclosure. The reflective structure 30 in FIG. 9 and FIG. 10 differs from that in FIG. 7 and FIG. 8 in that the plurality of first reflective strips 321 and the plurality of second reflective strips 322 are in two different layers. Specifically, the reflective structure 30 in some embodiments includes a first reflective layer having a plurality of first reflective strips 321 arranged along a first direction, each of the plurality of first reflective strips 321 extending substantially along a second direction; and a second reflective layer having a plurality of second reflective strips 322 arranged along the second direction, each of the plurality of second reflective strips 322 extending substantially along the first direction. Referring to FIG. 10, the reflective structure 30 in some embodiments further includes an insulating layer 324 between the first reflective layer and the second reflective layer.

In some embodiments, a projection of the reflective structure 30 on the base substrate substantially covers projections of the plurality of signal lines on the base substrate. Optionally, projections of the plurality of first reflective strips 321 on the base substrate substantially covers projections of the plurality of data lines on the base substrate; and projections of the plurality of second reflective strips 322 on the base substrate substantially covers projections of the plurality of gate lines on the base substrate. Optionally, projections of the plurality of first reflective strips 321 on the base substrate substantially covers projections of the plurality agate lines on the base substrate; and projections of the plurality of second reflective strips 322 on the base substrate substantially covers projections of the plurality of data lines on the base substrate.

Referring to FIG. 10, the reflective structure 30 in some embodiments further includes a transparent protective layer 323 on the first reflective strips 321 and the plurality of second reflective strips 322 to protect the first reflective strips 321 and the plurality of second reflective strips 322. Examples of appropriate protective materials include, but are not limited to, resin, silicon dioxide, silicon nitride, polyethylene terephthalate, and so on.

Various appropriate conductive reflective materials may be used for making the plurality of first reflective strips 321 and the plurality of second reflective strips 322. In some embodiments, the plurality of first reflective strips 321 and the plurality of second reflective strips 322 are made of a metal material such as aluminum and titanium alloy.

Various appropriate insulating materials may he used for making the insulating layer 324. Examples of appropriate insulating materials include, but are not limited to, resin, silicon dioxide, silicon nitride, polyethylene terephthalate, and so on.

Referring to FIG. 9 and FIG. 10, the plurality of first reflective strips 321 in some embodiments constitute a plurality of first touch electrodes; and the plurality of second reflective strips 322 constitute a plurality of second touch electrodes. The plurality of first touch electrodes are arranged along a first direction, each of the plurality of first touch electrodes extending substantially along a second direction; and the plurality of second touch electrodes are arranged along the second direction, each of the plurality of second touch electrodes extending substantially along the first direction. The reflective structure 30 is a dual-function structure for light reflection and touch detection. By integrating reflective layers and touch electrode layers in a single structure, the display substrate and a display apparatus having the display substrate can be miniaturized, e.g., having a minimized thickness.

In some embodiments, in numbers of adjacent reflective strips of the plurality of first reflective strips 321 are connected in parallel to form one of the plurality of first touch electrodes; and n numbers of adjacent reflective strips of the plurality of second reflective strips 322 are connected in parallel to form one of the plurality of second touch electrodes; m≥1, N≥1. Optionally, m=n. Optionally, m≠n. Optionally, m=3n. By having a plurality of reflective strips connected in parallel to form one of a plurality of touch electrodes, the number of output terminals in a touch driver chip can be reduced. In a typical display apparatus, the number of data lines is approximately three times of the number of gate lines. By having m set to be equal to approximately 3n, the touch control resolution along the first direction and along the second direction can be maintained substantially the same. In another example, the display panel is a 1920*1080 high resolution display panel, n=36, and the plurality of second reflective strips 322 constitute 30 touch electrodes.

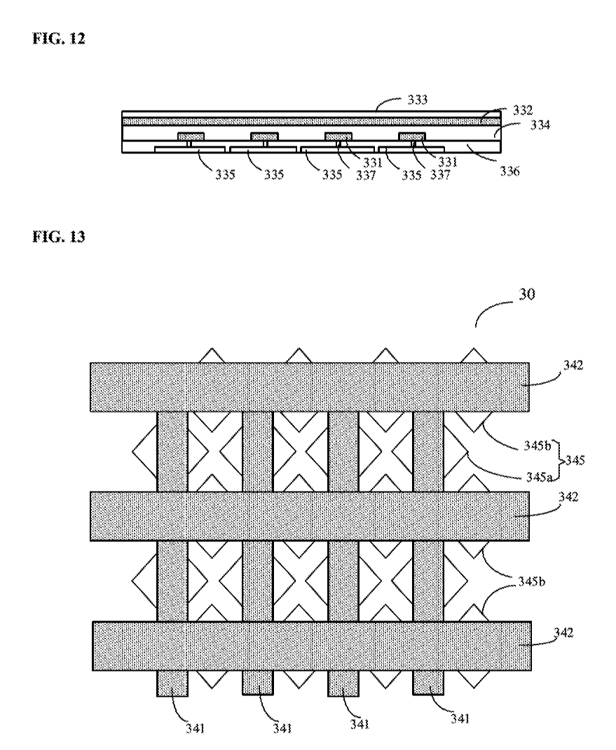

FIG. 11 is a schematic diagram illustrating the structure of a reflective structure in some embodiments according to the present disclosure. FIG. 12 is a cross-sectional view of a reflective structure in some embodiments according to the present disclosure. Referring to FIG. 11, the reflective structure 30 in some embodiments includes a first reflective layer having a plurality of first reflective strips 331 arranged along a first direction, each of the plurality of first reflective strips 331 extending substantially along a second direction; and a second reflective layer having a plurality of second reflective strips 332 arranged along the second direction, each of the plurality of second reflective strips 332 extending substantially along the first direction. Referring to FIG. 12, the reflective structure 30 in some embodiments further includes an insulating layer 334 between the first reflective layer and the second reflective layer. The reflective structure 30 in some embodiments further includes a transparent protective layer 333 on the first reflective strips 331 and the plurality of second reflective strips 332 to protect the first reflective strips 331 and the plurality of second reflective strips 332.

Referring to FIG. 11, the reflective structure 30 in some embodiments further includes a plurality of first transparent conductive blocks 335, each of which electrically connected to one of the plurality of first reflective strips 331. A projection of each of the plurality of first transparent conductive blocks 335 on the base substrate is between projections of two adjacent second reflective strips of the plurality of second reflective strips 332 on the base substrate. By having the plurality of first transparent conductive blocks 335, the capacitance between the plurality of first touch electrodes and the plurality of second touch electrodes can be increased, enhancing touch detection accuracy and sensitivity.

Referring to FIG. 12, the reflective structure 30 in some embodiments further includes a second insulating layer 336 between the plurality of first transparent conductive blocks 335 and the plurality of first reflective strips 331. The plurality of first transparent conductive blocks 335 are respectively electrically connected to the plurality of first reflective strips 331 through a plurality of vias 337 extending through the second insulating layer 336.

In some embodiments, the plurality of first transparent conductive blocks 335 include a plurality of rows of first transparent conductive blocks. Any two adjacent first transparent conductive blocks in each row of the plurality of rows of first transparent conductive blocks are electrically connected to two adjacent first reflective strips of the plurality of first reflective strips 331. Optionally, each of the plurality of first transparent conductive blocks has a rectangular shape.

In some embodiments, each of the plurality of first transparent conductive blocks 335 is electrically connected to one of the plurality of second reflective strips 332. A projection of each of the plurality of first transparent conductive blocks 335 on the base substrate is between projections of two adjacent first reflective strips of the plurality of first reflective strips 331 on the base substrate.

Various appropriate transparent conductive materials may be used to make the plurality of first transparent conductive blocks 335. Optionally, the plurality of first transparent conductive blocks 335 are made of a transparent metal material. Optionally, the plurality of first transparent conductive blocks 335 are made of a metal oxide material such as indium tin oxide.

FIG. 13 is a schematic diagram illustrating the structure of a reflective structure in some embodiments according to the present disclosure. FIG. 14 is a cross-sectional view of a reflective structure in some embodiments according to the present disclosure. Referring to FIG. 13, the reflective structure 30 in some embodiments includes a first reflective layer having a plurality of first reflective strips 341 arranged along a first direction, each or the plurality of first reflective strips 341 extending substantially along a second direction; and a second reflective layer having a plurality of second reflective strips 342 arranged along the second direction, each of the plurality of second reflective strips 342 extending substantially along the first direction. Referring to FIG. 12, the reflective structure 30 in some embodiments further includes an insulating layer 344 between the first reflective layer and the second reflective layer. The reflective structure 30 in some embodiments further includes a transparent protective layer 343 on the first reflective strips 341 and the plurality of second reflective strips 342 to protect the first reflective strips 341 and the plurality of second reflective strips 342.

Referring to FIG. 13, the reflective structure 30 in some embodiments further includes a plurality of first transparent conductive blocks 345a, each of which electrically connected to one of the plurality of first reflective strips 341; and a plurality of second transparent conductive blocks 345b, each of which electrically connected to one of the plurality of second reflective strips 342. A projection of each of the plurality of first transparent conductive blocks 345a on the base substrate is between projections of two adjacent second reflective strips of the plurality of second reflective strips 342 on the base substrate. A projection of each of the plurality of second transparent conductive blocks 345b on the base substrate is between projections of two adjacent first reflective strips of the plurality of first reflective strips 341 on the base substrate. By having the plurality of first transparent conductive blocks 345a and the plurality of second transparent conductive blocks 345b, the capacitance between the plurality of first touch electrodes and the plurality of second touch electrodes can be increased, enhancing touch detection accuracy and sensitivity.

In some embodiments, the plurality of first transparent conductive blocks 345a include a plurality of rows of first transparent conductive blocks; and the plurality of second transparent conductive blocks 345b include a plurality of rows of second transparent conductive blocks. Optionally, each of the plurality of rows of first transparent conductive blocks and each of the plurality of rows of second transparent conductive blocks are alternating with each other. Optionally, any two adjacent first transparent conductive blocks in each row of the plurality of rows of first transparent conductive blocks are electrically connected to two adjacent first reflective strips of the plurality of first reflective strips 341. Optionally, each second transparent conductive block in a same row of the plurality of rows of second transparent conductive blocks is electrically connected to a same second reflective strip of the plurality of second reflective strips 342.

Optionally, the plurality of first transparent conductive blocks 345a and the plurality of second transparent conductive blocks 345b are in a same'layer. Optionally, each of the plurality of first transparent conductive blocks has a rhomboid shape; and each of the plurality of second transparent conductive blocks has a rhomboid shape.

Referring to FIG. 13, the plurality of first transparent conductive blocks 345a are evenly distributed on the plurality of first reflective strips 341 (the plurality of first touch electrodes); and the plurality of second transparent conductive blocks 345b are evenly distributed on the plurality of second reflective strips 342 (the plurality of second touch electrodes). By having this design, the capacitances between the plurality of first touch electrodes and the plurality of second touch electrodes are substantially the same in various different positions of the display substrate, further enhancing touch accuracy and sensitivity.

Various appropriate transparent conductive materials may be used to make the plurality of first transparent conductive blocks 345a and the plurality of second transparent conductive blocks 345b. Optionally, the plurality of first transparent conductive blocks 345a and the plurality of second transparent conductive blocks 345b are made of a transparent metal material. Optionally, the plurality of first transparent conductive blocks 345a and the plurality of second transparent conductive blocks 345b are made of a metal oxide material such as indium tin oxide.

Referring to FIG. 14, the reflective structure 30 in some embodiments further includes a first insulating layer 344 between the plurality of first reflective strips 341 and the plurality of second reflective strips 342, and a second insulating layer 346 between the plurality of first transparent conductive blocks 345a and the plurality of first reflective strips 341. The plurality of first transparent conductive blocks 345a are respectively electrically connected to the plurality of first reflective strips 341 through a plurality of first vias 347 extending through the second insulating layer 336. The plurality of second transparent conductive blocks 345b are respectively electrically connected to the plurality of second reflective strips 342 through a plurality of second vias 348 extending through the first insulating layer 344 and the second insulating layer 336.

In some embodiments, the display substrate further includes a polarizer. Optionally, the polarizer is on a side of the plurality of thin film transistors and the plurality of signal lines distal to the base substrate. Optionally, the reflective structure is on a side of the base substrate proximal to the polarizer. Optionally, the reflective structure is on a side of the polarizer proximal to light incident side of the display substrate. Optionally, the display substrate further includes a protective layer between the polarizer and the reflective structure for protecting the polarizer.

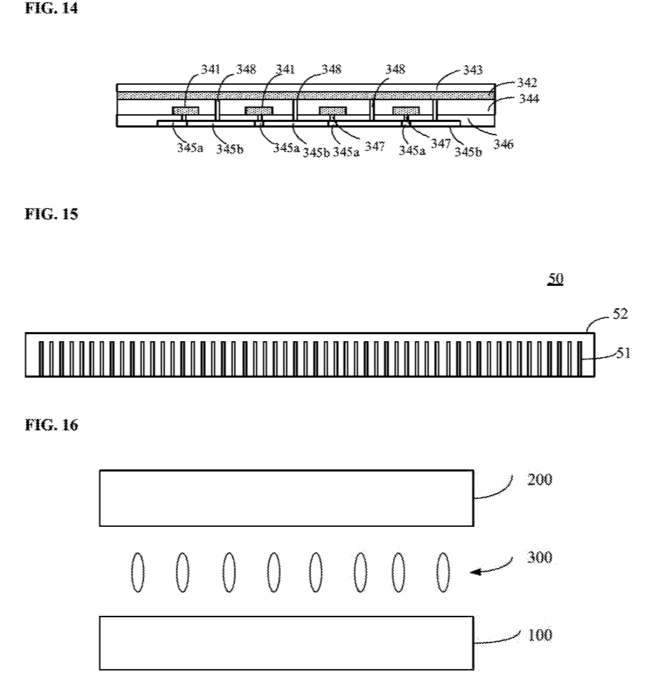

FIG. 15 is a schematic diagram illustrating the structure of a polarizer in some embodiments according to the present disclosure. Referring to FIG. 15, the polarizer in some embodiments includes a wire grid polarization gratings 51 and a protective layer 52 on the wire grid polarization gratings 51. The wire grid polarization gratings 51 may be fabricated by, e.g., nano-imprinting. Optionally, the polarizer depicted in FIG. 15 is a polarizer on a side of the base substrate distal to the light incident side of the display substrate (see, e.g., the polarizer 50 in FIGS. 6A, 6C, and 6D). The wire grid polarization gratings 51 includes a plurality of parallel metal wires, adjacent metal wires form a plurality of grooves. The pitch of the wire grid polarization gratings 51 may be set to be one half or one quarter of the wavelength of the incident light from a back light.

In another aspect, the present disclosure further provides a display panel including a display substrate described herein. FIG. 16 is a schematic diagram illustrating the structure of a display panel in some embodiments according to the present disclosure. Referring to FIG. 16, the display panel in some embodiments includes an array substrate 100, a color filter substrate 200, and a liquid crystal layer 300 between the array substrate 100 and the color filter substrate 200. Optionally, the array substrate 100 is a display substrate described herein (e.g., the display substrate depicted in FIGS. 3 to 5, and 6A to 6F). Optionally, the color filter substrate 200 is a display substrate described herein (e.g., the display substrate depicted in FIGS. 3 to 5, and 6A to 6F).

In another aspect, the present disclosure further provides a display apparatus including a display substrate described herein. Examples of appropriate display apparatuses includes, but are not limited to, an electronic paper, a mobile phone, a tablet computer, a television, a monitor, a notebook computer, a digital album, a UPS, etc.

FIG. 17 is a schematic diagram illustrating the structure of a display apparatus in some embodiments according to the present disclosure. Referring to FIG. 17, the display apparatus in some embodiments includes a back light 400 and a display panel. The display panel includes an array substrate 100, a color filter substrate 200, and a liquid crystal layer 300 between the array substrate 100 and the color filter substrate 200. In FIG. 17, the array substrate 100 is a display substrate described herein (e.g., the display substrate depicted in FIGS. 3 to 5, and 6A to 6F). The allay substrate 100 is between the back light 400 and the color filter substrate 200.

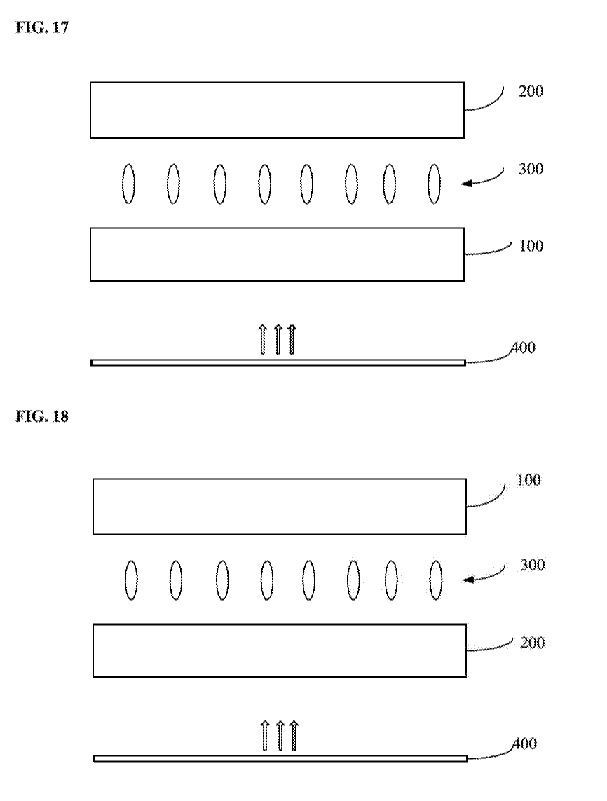

FIG. 18 is a schematic diagram illustrating the structure of a display apparatus in some embodiments according to the present disclosure. Referring to FIG. 18, the display apparatus in some embodiments includes a back light 400 and a display panel. The display panel includes an array substrate 100, a color filter substrate 200, and a liquid crystal layer 300 between the array substrate 100 and the color filter substrate 200. In FIG. 18, the color filter substrate 200 is a display substrate described herein (e.g., the display substrate depicted in FIGS. 3 to 5, and 6A to 6F). The color filter substrate 200 is between the back light 400 and the array substrate 100.

In another aspect, the present disclosure provides a method of fabricating a display substrate having a subpixel region and an inter-subpixel region. In some embodiments, the method includes forming a reflective structure in the inter-subpixel region configured to reflect light emitted from a back light toward the inter-subpixel region of the display substrate back to the back light while allowing light transmit through the subpixel region.

In some embodiments, the method further includes forming pixel components on a base substrate. Optionally, the display substrate is an array substrate, and the method includes forming a plurality of pixel electrodes and a plurality of common electrodes in the subpixel region, and forming a plurality of thin film transistors and a plurality of signal lines (e.g., a plurality of gate lines and a plurality of data lines) in the inter-subpixel region. Optionally, the display substrate is a color filter substrate, and the method further includes forming a plurality of color filter in the subpixel region, and forming a black matrix layer in the inter-subpixel region. Optionally, the reflective structure is formed on a side of the pixel components (e.g., the plurality of thin film transistors and the plurality of signal lines) proximal to the back light. Optionally, the reflective structure is formed on a side of the pixel components (e.g., the plurality of thin film transistors and the plurality of signal lines) proximal to a light incident side of the display substrate. Optionally, the display substrate is formed so that a projection the reflective structure on the base substrate substantially covers projections of the plurality of signal lines on the substrate.

Optionally, the step of forming the reflective structure includes forming a plurality of touch electrodes configured to detect a touch. Optionally, each of the plurality of touch electrodes is,light reflective and configured to reflect light emitted from the back light toward the inter-subpixel region of the display substrate back to the back light.

Optionally, the reflective structure is formed on a side of the base substrate distal to the pixel components of the display substrate (e.g., the plurality of thin film transistors and the plurality of signal lines). Optionally, the reflective structure is formed on a side of the base substrate proximal to the light incident side of the display substrate, e.g., proximal to the back light.

Optionally, the reflective structure is formed on a side of the base substrate proximal to the pixel components of the display substrate (e.g., the plurality of thin film transistors and the plurality of signal lines). Optionally, the reflective structure is formed on a side of the base substrate distal to the light incident side of the display substrate, e.g., distal to the back light.

Optionally, the reflective structure is directly formed on the base substrate by a patterning process. Optionally, the reflective structure is adhered onto the base substrate. Optionally, the method further includes forming an adhesive layer for adhering the reflective structure onto the base substrate.

In some embodiments, the method further includes fanning a polarizer. Optionally, the polarizer is between the reflective structure 30 and the pixel components of the display substrate. Optionally, the reflective structure is formed between the polarizer and the pixel components of the display substrate. Optionally, the polarizer and the reflective structure are formed on a same side of the base substrate. Optionally, the polarizer and the reflective structure are formed on different sides of the base substrate, e.g., the polarizer is formed on a side of the base substrate distal to the reflective structure.

Optionally, the polarizer is formed on a side of the base substrate distal to the reflective structure, e.g., the polarizer and the reflective structure are formed on two opposite sides of the base substrate. Optionally, the polarizer and the reflective structure are formed on a same side of the base substrate. Optionally, the polarizer, the reflective structure, and pixel components of the display substrate (e.g., a plurality of thin film transistors and a plurality of signal lines) are formed on a same side of the base substrate. Optionally, the polarizer and the reflective structure are formed on a same side of the base substrate. Optionally, the polarizer and the reflective structure are formed on a side of the base substrate distal to various pixel components (e.g., a plurality of thin film transistors and a plurality of signal lines) of the display substrate. Optionally, the reflective structure is formed on a side of the polarizer proximal to the back light, e.g., proximal to the light incident side of the display substrate.

In some embodiments, the step of forming the reflective structure includes forming a plurality of first reflective strips arranged along a first direction, and forming a plurality of second reflective strips arranged along the second direction. Optionally, each of the plurality of first reflective strips is formed to extend substantially along a second direction. Optionally, each of the plurality of second reflective strips is formed to extend substantially along the first direction.

Optionally, the plurality of first reflective strips and the plurality of second reflective strips are formed in a same layer, in a single patterning process (e.g., with a single mask plate), and using a same material.

Optionally, the plurality of first reflective strips and the plurality of second reflective strips are formed in different layers. Specifically, the step of forming the reflective structure includes forming a first reflective layer and forming a second reflective layer. The step of forming the first reflective layer includes forming a plurality of first reflective strips arranged along a first direction, each of the plurality of first reflective strips being formed to extend substantially along a second direction. The step of forming the second reflective layer includes forming a plurality of second reflective strips arranged along the second direction, each of the plurality of second reflective strips being formed to extend substantially along the first direction. Optionally, the step of formula the reflective structure further includes forming an insulating layer between the first reflective layer and the second reflective layer.

Optionally, the reflective structure is formed so that projections of the plurality of first reflective strips on the base substrate substantially covers projections of the plurality of data lines on the base substrate; and projections of the plurality of second reflective strips on the base substrate substantially covers projections of the plurality of gate lines on the base substrate. Optionally, the reflective structure is formed so that projections of the plurality of first reflective strips on the base substrate substantially covers projections of the plurality of gate lines on the base substrate; and projections of the plurality of second reflective strips on the base substrate substantially covers projections of the plurality of data lines on the base substrate.

In some embodiments, the display substrate is a color filter substrate, and the method includes forming a plurality of color filters and a black matrix on the base substrate. Optionally, the reflective structure is formed so that the projection of the reflective structure on the base substrate substantially overlaps with that of the black matrix layer. Optionally, the reflective structure is formed so that the projection of the black matrix layer on the base substrate substantially covers that of the reflective structure.

Optionally, the step of forming the reflective structure further includes forming a transparent protective layer on the first reflective strips and the plurality of second reflective strips to protect the first reflective strips and the plurality of second reflective strips.

In some embodiments, the plurality of first reflective strips constitute a plurality of first touch electrodes; and the plurality of second reflective strips constitute a plurality of second touch electrodes. Optionally, the method further includes electrically connecting m numbers of adjacent reflective strips of the plurality of first reflective strips in parallel to form one of the plurality of first touch electrodes; and electrically connecting n numbers of adjacent reflective strips of the plurality of second reflective strips in parallel to form one of the plurality of second touch electrodes, m≥1, N≥1. Optionally, m≠n. Optionally, m≠n. Optionally, m=3n.

In some embodiments, the method further includes forming a plurality of first transparent conductive blocks, and electrically connecting each of the plurality of first transparent conductive blocks to one of the plurality of first reflective strips. Optionally, the plurality of first transparent conductive blocks are formed so that a projection of each of the plurality of first transparent conductive blocks on the base substrate is between projections of two adjacent second reflective strips of the plurality of second reflective strips on the base substrate. Optionally, the step of forming the plurality of first transparent conductive blocks includes forming a plurality of rows of first transparent conductive blocks. Optionally, the plurality of rows of first transparent conductive blocks are formed so that any two adjacent first transparent conductive blocks in each row of the plurality of rows of first transparent conductive blocks are electrically connected to two adjacent first reflective strips of the plurality of first reflective strips. Optionally, each of the plurality of first transparent conductive blocks is formed to have a rectangular shape.

In some embodiments, the method further includes forming a plurality of first transparent conductive blocks, electrically connecting each of the plurality of first transparent conductive blocks to one of the plurality of first reflective strips, forming a plurality of second transparent conductive blocks, and electrically connecting each of the plurality of second conductive blocks to one of the plurality of second reflective strips. Optionally, the plurality of first transparent conductive blocks are formed so that a projection of each of the plurality of first transparent conductive blocks on the base substrate is between projections of two adjacent second reflective strips of the plurality of second reflective strips on the base substrate. Optionally, the plurality of second transparent conductive blocks are formed so that a projection of each of the plurality of second transparent conductive blocks on the base substrate is between projections of two adjacent first reflective strips of the plurality of first reflective strips on the base substrate.

In some embodiments, the step of forming the plurality of first transparent conductive blocks includes forming a plurality of rows of first transparent conductive blocks, and the step of forming the plurality of second transparent conductive blocks includes forming a plurality of rows of second transparent conductive blocks. The plurality of rows of first transparent conductive blocks and the plurality of second transparent conductive blocks are formed so that each of the plurality of rows of first transparent conductive blocks and each of the plurality of rows of second transparent conductive blocks are alternating with each other; any two adjacent first transparent conductive blocks in each row of the plurality of rows of first transparent conductive blocks are electrically connected to two adjacent first reflective strips of the plurality of first reflective strips; and each second transparent conductive block in a same row of the plurality of rows of second transparent conductive blocks is electrically connected to a same second reflective strip of the plurality of second reflective strips. Optionally, each of the plurality of first transparent conductive blocks is formed to have a rhomboid shape; and each of the plurality of second transparent conductive blocks is formed to have a rhomboid shape

Optionally, the plurality of first transparent conductive blocks and the plurality of second transparent conductive blocks are in a same layer, in a single patterning process (e.g., with a single mask plate), and using a same material.

In some embodiments, the method further includes forming a polarizer on the base substrate. Optionally, the polarizer is formed on a side of the plurality of thin film transistors and the plurality of signal lines distal to the base substrate. Optionally, the reflective structure is formed on a side of the base substrate proximal to the polarizer. Optionally, the reflective structure is formed on a side of the polarizer proximal to light incident side of the display substrate.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A display substrate having a subpixel region and an inter-subpixel region, comprising a base substrate, and a reflective structure in the inter-subpixel region configured to reflect light emitted from a back light toward the inter-subpixel region of the display substrate back to the back light while allowing light transmit through the subpixel region.

2. The display substrate of claim 1, further comprising a plurality of thin film transistors and a plurality of signal lines for driving light emission of the display substrate;
wherein the reflective structure is on a side of the plurality of thin film transistors and the plurality of signal lines proximal to the back light.

3. The display substrate of claim 2, wherein a projection of the reflective structure on the base substrate substantially covers projections of a plurality of gate lines and a plurality of data lines on the base substrate.

4. The display substrate of claim 1, wherein the reflective structure comprises a plurality of touch electrodes configured to detect a touch;
each of the plurality of touch electrodes is light reflective and configured to reflect light emitted from the back light toward the inter-subpixel region of the display substrate back to the back light.

5. The display substrate of claim 1, wherein the reflective structure comprises:
a plurality of first reflective strips arranged along a first direction, each of the plurality of first reflective strips extending substantially along a second direction; and
a plurality of second reflective strips arranged along the second direction, each of the plurality of second reflective strips extending substantially along the first direction.

6. The display substrate of claim 1, wherein the reflective structure comprises:
a first reflective layer comprising a plurality of first reflective strips arranged along a first direction, each of the plurality of first reflective strips extending substantially along a second direction;
a second reflective layer comprising a plurality of second reflective strips arranged along the second direction, each of the plurality of second reflective strips extending substantially along the first direction; and
an insulating layer between the first reflective layer and the second reflective layer.

7. The display substrate of claim 6, wherein the plurality of first reflective strips constitute a plurality of first touch electrodes; and
the plurality of second reflective strips constitute a plurality of second touch electrodes.

8. The display substrate of claim 7, wherein m numbers of adjacent reflective strips of the plurality of first reflective strips are connected in parallel to form one of the plurality of first touch electrodes;
n numbers of adjacent reflective strips of the plurality of second reflective strips are connected in parallel to form one of the plurality of second touch electrodes; and
m=3n.

9. The display substrate of claim 6, further comprising a plurality of first transparent conductive blocks, each of which electrically connected to one of the plurality of first reflective strips;
wherein a projection of each of the plurality of first transparent conductive blocks on the base substrate is between projections of two adjacent second reflective strips of the plurality of second reflective strips on the base substrate.

10. The display substrate of claim 9, wherein the plurality of first transparent conductive blocks comprise a plurality of rows of first transparent conductive blocks; and
any two adjacent first transparent conductive blocks in each row of the plurality of rows of first transparent conductive blocks are electrically connected to two adjacent first reflective strips of the plurality of first reflective strips.

11. The display substrate of claim 9, wherein each of the plurality of first transparent conductive blocks has a rectangular shape.

12. The display substrate of claim 9, further comprising a plurality of second transparent conductive blocks, each of which electrically connected to one of the plurality of second reflective strips;
wherein a projection of each of the plurality of second transparent conductive blocks on the base substrate is between projections of two adjacent first reflective strips of the plurality of first reflective strips on the base substrate.

13. The display substrate of claim 12, wherein the plurality of first transparent conductive blocks comprise a plurality of rows of first transparent conductive blocks;
the plurality of second transparent conductive blocks comprise a plurality of rows of second transparent conductive blocks;
each of the plurality of rows of first transparent conductive blocks and each of the plurality of rows of second transparent conductive blocks are alternating with each other;
any two adjacent first transparent conductive blocks in each row of the plurality of rows of first transparent conductive blocks are electrically connected to two adjacent first reflective strips of the plurality of first reflective strips; and
each second transparent conductive block in a same row of the plurality of rows of second transparent conductive blocks is electrically connected to a same second reflective strip of the plurality of second reflective strips.

14. The display substrate of claim 12, wherein the plurality of first transparent conductive blocks and the plurality of second transparent conductive blocks are in a same layer.

15. The display substrate of claim 12, wherein each of the plurality of first transparent conductive blocks has a rhomboid shape; and each of the plurality of second transparent conductive blocks has a rhomboid shape.

16. The display substrate of claim 2, further comprising a polarizer on the base substrate;
wherein the polarizer is on a side of the plurality of thin film transistors and the plurality of signal lines distal to the base substrate.

17. The display substrate of claim 16, wherein the reflective structure is on a side of the base substrate proximal to the polarizer.

18. The display substrate of claim 17, wherein the reflective structure is on a side of the polarizer proximal to light incident side of the display substrate.

19. A display apparatus, comprising the display substrate of claim 1.

20. A method of fabricating a display substrate having a subpixel region and an inter-subpixel region, comprising forming a reflective structure in the inter-subpixel region configured to reflect light emitted from a back light toward the inter-subpixel region of the display substrate back to the back light while allowing light transmit through the subpixel region.
